(19) United States
(12) Patent Application Publication
(10) Pub. No.: US 2018/0122418 A1
(43) Pub. Date: May 3, 2018

(54) ULTRASONIC MOLDING OF THIN WALL OPTICAL COMPONENTS

(71) Applicant: Johnson & Johnson Vision Care, Inc., Jacksonville, FL (US)

(72) Inventors: Victor Lust, Jacksonville, FL (US); Jeffrey Miller, Jacksonville, FL (US); David Porter, Rochester, NY (US); Praveen Pandojirao, Jacksonville, FL (US); Randall B. Pugh, Jacksonville, FL (US)

(73) Assignee: Johnson & Johnson Vision Care, Inc., Jacksonville, FL (US)

(21) Appl. No.: 15/802,672

(22) Filed: Nov. 3, 2017

Related U.S. Application Data
(60) Provisional application No. 62/416,943, filed on Nov. 3, 2016.

(51) Int. Cl. G11B 7/26; B29D 17/00; B29C 45/26; B29C 45/56

(52) U.S. Cl. CPC G11B 7/26; B29D 17/005; B29L 2017/001; B29C 45/568; B29C 45/263

(57) ABSTRACT

An ultrasonic molding device for molding thin-walled optical components which includes an ultrasonic assembly and a plunger assembly for melting thermoplastic material and injecting it into a mold under reduced pressure conditions.

### CROSS REFERENCE TO RELATED APPLICATIONS

This application claims the benefit of U.S. Provisional Application No. 62/416,943, filed Nov. 3, 2016, which is incorporated herein by reference in its entirety.

### FIELD OF THE INVENTION

The present invention relates to an ultrasonic molding device, and more particularly, to an ultrasonic micro-molding device for forming thin-walled, birefringence-free optical components, and the process thereof.

### BACKGROUND OF THE INVENTION

Thin-walled optical components are typically formed via traditional injection molding processes. In such processes, injection molding devices typically melt a thermoplastic material at a first location, and then force the molten material down a relatively long passageway and into to a mold cavity whereupon it solidifies to form the desired optical component. Often, melting of the thermoplastic material is accomplished via a combination of mechanical agitation and heat, such as in a reciprocating screw-type extruder or comparable apparatus. Such an apparatus not only melts and mixes the material, but also applies sufficient force to the molten material through its mechanical action to push the molten material through the passageway and into the mold.

While such processes have proven useful for the fabrication of articles of various shapes and sizes, they have presented numerous challenges when it comes to the formation of small components for optical applications. For example, the mechanical actions of the screw-type extruder used to melt and inject the molten material imparts significant shear stress and strain within the molten material. Further, as the molten material is forced down the passageway to the mold, it is subjected to additional shear stress and strain from its contact with the passageway walls. Unfortunately, the shear stress and strain imparted to the material prior to curation often increase the inherent viscosity of the material and lead to residual stresses that reduce the overall quality and clarity of the cured optical component.

In addition, standard injection molding processes typically subject the molten material to elevated temperatures and pressures for a time of between 1 to 5 minutes prior to curation. Such lengthy exposure to the temperatures required to maintain the material in a molten state of suitable viscosity further degrades the material's properties.

In the fabrication of optical components, it is often desirable to produce components exhibiting as little birefringence as possible. However, the shear stress, strain, increased inherent viscosity and thermal degradation that accompanies traditional injection molding processes generally leads to significant birefringence in molded optical components.

Accordingly, there exists a need for a molding device and process suitable for the fabrication of thin-walled optical components with reduced residual internal stress and little or no birefringence. Such a need is met by the ultrasonic molding apparatus and process described herein.

### SUMMARY OF THE INVENTION

The present invention provides an ultrasonic micro-molding device and process suitable for manufacturing thin-walled optical components with reduced internal stress and little or no birefringence. Advantageously, the thermoplastic material is melted by vibrational energy in a low pressure environment without the introduction of significant shear stress or strain into the molten material. Additionally, the material may be melted in a chamber in close proximity to the mold such that relatively low pressures are required to transport the molten material from the melting chamber to the mold, and minimal shear stress and strain is imparted to the molten material during its traverse. The efficiency of ultrasonic melting, coupled with the ability to melt the material in close proximity to the mold also allows for reduced cycle times and, consequently, less thermal degradation of the molten material.

The ultrasonic molding device generally includes a first mold block including a first mold insert having a first mold cavity defining portion, a horn chamber, a first passageway formed along a mating surface of the first mold block between the horn chamber and the first mold cavity defining portion, and a second mold block including a second mold insert having a second mold cavity defining portion configured to operatively engage the first mold cavity defining portion, a plunger chamber configured to be axially aligned with the horn chamber, and a second passageway formed in a mating surface of the second mold block between the plunger chamber and the second mold cavity defining portion. The device further includes a vibration element configured to be positioned in the horn chamber and switched between an inactive and active state, and a plunger assembly comprising a plunger pin configured to reciprocate within the plunger chamber.

The molding device is movable between an open and closed position, wherein in the closed position, the mating surface of the first mold block engages the mating surface of the second mold block such that the first mold cavity defining portion and the second mold cavity defining portion cooperatively form a mold cavity configured to form a thin-walled optical component, the horn chamber and plunger chamber axially align to form a melting chamber between the plunger pin and the vibration element, and the first passageway and the second passageway longitudinally align forming a runner configured to deliver molten thermoplastic material from the melting chamber to the mold cavity.

In certain embodiments, the longitudinal axis of the runner is orthogonal to the longitudinal axis through the horn and/or plunger chambers. In some embodiments, the runner has a ratio of cross-sectional area to length in the range of from about 0.2 to 1.0. In some embodiments the runner is cylindrical with a diameter in the range of from about 1.0 mm to about 5.0 mm. In some embodiments the runner has a length less than 25 mm, preferably in the range of from about 8 mm to about 20 mm.

According to another embodiment of the device, the vibration element includes a sonotrode configured to be axially aligned with the horn chamber and moved between a first position and a second position to engage material provided in the melting chamber.

According to another embodiment, the device further includes a material feed assembly configured to deliver thermoplastic material to the melting chamber. In certain embodiments, the thermoplastic material is delivered to the melting chamber through an inlet formed in the horn chamber. In some embodiments, movement of the vibration element into its engaged position within the horn chamber seals the feed inlet.

According to another embodiment of the device, movement of the plunger pin toward the vibration element expels the molten thermoplastic material from the melting chamber through the runner and into the mold cavity. In certain embodiments, the minimum distance between the vibration element and the plunger pin during expulsion of the molten thermoplastic material from the melt chamber is at least 1.0 mm, and preferably in the range of from about 2.0 mm to about 6.0 mm.

According to another embodiment of the device, the first mold cavity defining portion and the second mold cavity defining portion are configured to cooperatively form a thin-walled optical component having a thickness of from about 0.025 mm to about 0.30 mm. In certain embodiments, the first mold cavity defining portion has a concave surface configured to form an exterior portion of the optical component, and the second mold cavity defining portion has a convex surface configured to form an interior portion of the optical component, the interior portion configured to engage a cornea of a user's eye.

In other embodiments, the invention provides a method of forming thin-walled optical components which comprises:
(1) providing a molding device comprising: a first mold block including a first mold insert having a first mold cavity defining portion, a horn chamber configured to receive an ultrasonic assembly, and a first passageway formed along a mating surface of the first mold block; a second mold block including a second mold insert having a second mold cavity defining portion, a plunger chamber configured to receive a plunger assembly, and a second passageway formed along a mating surface of the second mold block configured to align with the first passageway; an ultrasonic assembly including a vibration element configured to move axially into the horn chamber; a plunger assembly including a plunger pin configured to move axially within the plunger chamber; and a material feeder capable of providing thermoplastic material to the horn chamber;
(2) placing the first mold block in engagement with the second mold block such that the first mold cavity defining portion and second mold cavity defining portion cooperatively form a mold cavity, the plunger chamber and horn chamber are aligned and define a melting chamber between the vibration element and the plunger pin, and the first passageway and second passageway are aligned to form a runner between the mold cavity and the melting chamber;
(3) introducing solid thermoplastic material from the material feeder into the melting chamber;
(4) moving the ultrasonic assembly into position in the horn chamber such that a tip of the vibration element is located adjacent to the thermoplastic material in the melting chamber;
(5) activating the ultrasonic assembly such that vibrational energy of a predetermined magnitude engages the thermoplastic material thereby melting the thermoplastic material;
(6) moving the plunger pin in the plunger chamber towards the vibration element thereby expelling molten thermoplastic material through the runner into the mold cavity;
(7) curing the material in the mold cavity thereby forming a thin-walled optical component; and
(8) demolding the thin-walled optical component from the mold cavity.

In certain embodiments, the method includes melting the thermoplastic material and injecting it into the mold in a time of less than about 20 seconds. In some embodiments, the melting time is less than about 10 seconds. Additionally, in some embodiments the entire cycle time from introduction of the thermoplastic material into the melting chamber to demolding of the formed optical component is less than about 90 seconds.

In other embodiments, the method provides optical components having little or no birefringence. Preferably, the molded articles have less than 30 nanometers retardation in refractive index, more preferably, less than 10 nanometers retardation.

In other embodiments, the plunger pin exerts a force on the molten thermoplastic material of less than 12,000 N, preferably in the range of from about 2,000 N to about 6,000 N, to expel it from the melting chamber.

In some embodiments, the vibrational element generates a power of from about 1.0 kW to about 1.5 kW to melt the thermoplastic material.

In some embodiments, the vibration induces a temperature of from about 200° C. to about 300° C. in the thermoplastic material.

### BRIEF DESCRIPTION OF THE DRAWINGS

FIG. 1 is an environmental, cross-sectional, side view of a molding device of the invention illustrating the device in a generally open position.

FIG. 2 is an environmental, cross-sectional, side view of a molding device of the invention illustrating the device in a generally closed position.

FIG. 3 is an environmental, cross-sectional, side view of a molding device of the invention illustrating the device in a closed position with the ultrasonic vibrational element in an engaged position.

The foregoing summary, as well as the following detailed description of the invention, will be better understood when read in conjunction with the appended figures. For the purpose of illustrating the invention, the figures demonstrate embodiments of the present invention. It should be understood, however, that the invention is not limited to the precise arrangements, examples, and instrumentalities shown.

### DETAILED DESCRIPTION

Without further description, it is believed that one of ordinary skill in the art may, using the preceding description and the following illustrative examples, make and utilize the present invention and practice the claimed methods. The following working examples, therefore, specifically point out preferred embodiments of the present invention, and are not to be construed as limiting in any way the scope of the invention.

The present invention provides for a low pressure micro-molding device that uses ultrasonic vibrational energy to mold one or more thin-walled, birefringence-free, optical components, and the process thereof. As used herein:

(1) “micro-molding” refers to the molding of articles having a largest dimension in the range of from about 5 mm to about 10 mm;

(2) “thin-walled” refers to articles having a wall thickness in the range of from about 0.025 mm to about 0.30 mm; and

(3) “birefringence free” means less than about 10 nanometers retardation in refractive index measured with a polarscope.

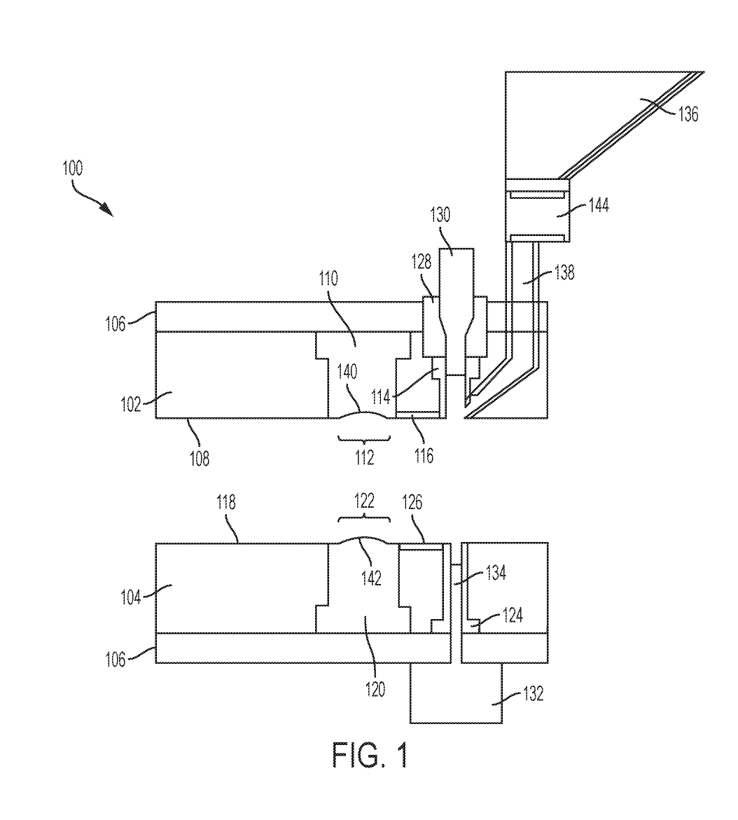

Referring now to FIG. 1, there is shown an ultrasonic device for micro-molding thin-walled optical components, generally referred to by the reference number 100. The molding device 100 includes a first mold block 102, and a second mold block 104, positioned between backing plates 106 and configured for operative engagement.

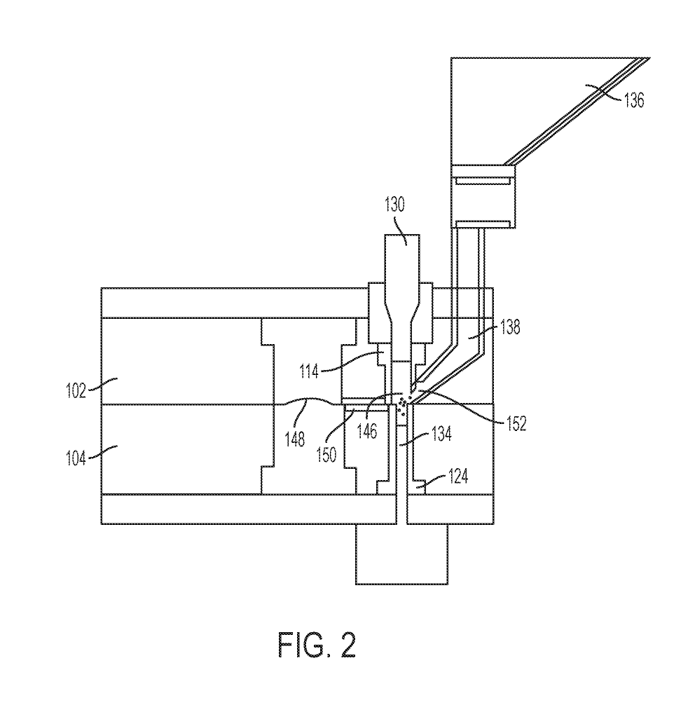

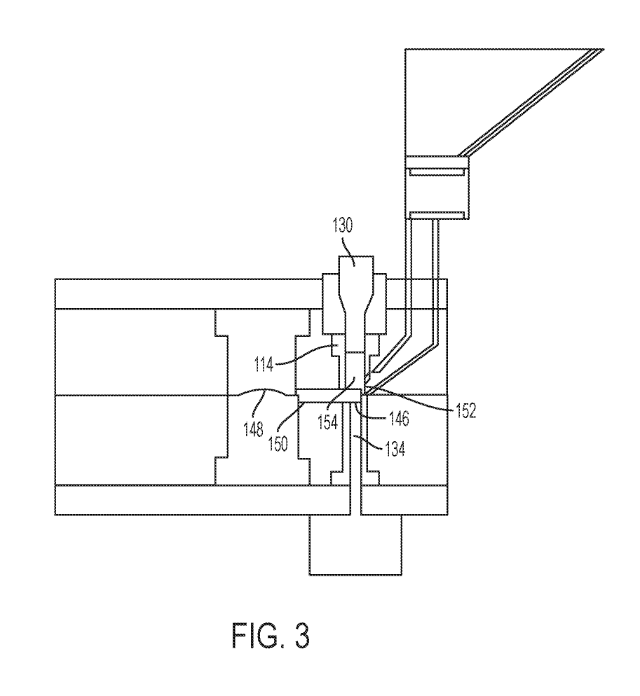

The first mold block 102, is adapted for movement via a mold press (not shown) between a first position, in which the first and second mold blocks 102, 104 are disengaged as shown, and a second position, in which the first and second mold blocks 102, 104 are operatively engaged, as illustrated in FIGS. 2 and 3. The first mold block 102 includes a first mating surface 108. The first mold block 102 further includes a first mold insert 110 having a first mold cavity defining portion 112 with a mold defining surface 140, a horn chamber 114, and a first passageway 116 formed along the first mating surface 108 between the horn chamber 114 and first mold cavity defining portion 112.

The second mold block 104 includes a second mating surface 118 aligned to operatively engage the first mating surface 108 of the first mold block 102. The second mold block 104 further includes a second mold insert 120 having a second mold cavity defining portion 122 with a mold defining surface 142, configured to operatively engage the first mold cavity defining portion 112.

The second mold block 104 further includes a plunger chamber 124 configured for axial alignment with the horn chamber 114, and a second passageway 126 formed in the second mating surface 118 between the plunger chamber 124 and the second mold cavity defining portion 122.

The ultrasonic molding device 100 further includes an ultrasonic assembly 128 for generating high frequency vibrational energy at a predetermined magnitude. The ultrasonic assembly 128 may be switched between an inactive and an active state, in which the ultrasonic assembly 128 generates vibrational energy for melting thermoplastic material. The ultrasonic assembly 128 generally includes a vibration element 130, such as a sonotrode or a similar type device, capable of generating vibrational energy at a magnitude sufficient for melting thermoplastic material.

The horn chamber 114 extends through the first mold block 102 providing a passageway for the vibration element 130 to move between a first, unengaged, position and a second, engaged, position. The vibrational element 130 is actuated between such positions by a drive mechanism (not shown).

The vibration element 130 may be a sonotrode capable of generating vibrational power at a frequency in the range of about 15 kHz to about 70 kHz, and generating a temperature within the thermoplastic material in the range of from about 20° C. to about 325° C. Preferably, the sonotrode vibrates at a frequency of from about 20 kHz to 30 kHz and generates a temperature between 200° C. and 300° C., more preferably a temperature between 240° C. and 285° C. The vibration element 130 preferably has a diameter of from about 4 mm to about 12 mm, more preferably from about 7 mm to about 9 mm.

The molding device 100 further includes a plunger assembly 132 including a plunger pin 134 movable within the plunger chamber 124. The plunger pin 134 is disposed within the plunger chamber 124, and moves in a reciprocating manner by a drive mechanism (not shown). The plunger pin 134 generally has a diameter of from about 6 mm to about 14 mm, preferably from about 7 mm to about 9 mm. Additionally, the gap between the plunger pin 134 and the sides of the plunger chamber 124 should be small, preferably less than 0.01 mm, to minimize entry of the molten polymer into the gap.

The molding device 100 may additionally include a material feed assembly including a hopper 136 and a supply tube 138. Further, the feed assembly may include a metering or measuring device 144 to control the amount of thermoplastic material fed to the melting chamber.

Molding of thin-walled components generally occurs when the first mold block 102 and second mold block 104 are in a closed, engaged position as shown in FIGS. 2 and 3. In such position, the horn chamber 114 and plunger chamber 124 align, and a melting chamber 146 is formed between the vibration element 130 and the plunger pin 134.

The first mold insert 110 and first mold cavity defining portion 112 and second mold insert 120 and second mold cavity defining portion 122 cooperatively form a mold cavity 148. Mold cavity defining portions 112 and 122, each have respective mold defining surfaces 140 and 142 configured to form a thin-walled, birefringence-free, optical component. For example, mold defining surface 140 may be generally concave and configured to form an exterior portion of the thin-walled optical component, and mold defining surface 142 may be generally convex and configured to form an interior portion of the optical component.

As illustrated, the first and second mating surfaces 108 and 118 come together such that passageways 116, and 126 are in alignment with each other and cooperatively define a runner 150 between the mold cavity 148 and melting chamber 146, to facilitate the flow of molten material from the melting chamber 146 to the mold cavity 148 during the molding process.

The runner 150 may have any cross-sectional shape and size that is efficient for the transfer of molten material from the melting chamber 146 to the mold cavity 148 under low pressure conditions with little introduction of shear stress and strain to the material. The length of runner 150 is determined by the proximity of the horn chamber 114 to the mold inserts 110, 124. Typically, runner 150 is less than about 25 mm in length. Preferably, the length of runner 150 is from about 8 mm to about 20 mm, more preferably from about 12 mm to about 16 mm. Particularly useful configurations of runner 150 include those having a cross-sectional shape that is circular, square or rectangular. However, cylindrical runners are generally preferred. Such runners preferably have diameters in the range of from about 1 mm to about 5 mm, more preferably from about 2 mm to about 4 mm. Suitable runners generally have a ratio of cross-sectional area to length that is in the range of from about 0.03 to about 4.0. Preferably, the runner 150 has a ratio of cross-sectional area to length of between about 0.04 and 2.5, more preferably between about 0.2 and 1.0. The runner 150 is preferably formed orthogonal to the melting chamber 146, such that as molten material flows through the runner 146 it travels in a direction generally perpendicular to the longitudinal axis of melting chamber 146.

In operation, first mold block 102 and second mold block 104 are moved into an engaged position by the drive mechanism, such that the first mating surface 108 and second mating surface 118 are engaged. As such, the first mold cavity defining portion 112 and second mold cavity defining portion 122 are aligned forming the mold cavity 148. The horn chamber 114 and plunger chamber 124 are aligned axially, defining the melting chamber 146 between the terminal ends of the vibration element 130 and the plunger pin 134 disposed, respectively, therein. Further, the first and second passageways 116 and 126, align longitudinally, forming runner 150 between the melting chamber 146 and the mold cavity 148.

When the mold blocks are engaged, thermoplastic material is fed from the hopper 136 to the melting chamber 146 through a feed inlet 152 in the wall of the horn chamber 114 via the supply tube 138. Thereafter, as shown in FIG. 3, vibration element 130 is moved in horn chamber 114 into an engaged position, such that its end portion 154 is adjacent to the thermoplastic material in the melting chamber 146. Preferably, in its engaged position, vibration element 130 seals the feed inlet 152.

Activation of the vibration element 130 melts the thermoplastic material. Preferably, the vibration element vibrates at a frequency of from about 20 kHz to about 30 kHz and imparts from about 1.0 kW to about 1.5 kW of power to the thermoplastic material. Such power preferably raises the temperature of the thermoplastic material to within the range of 240° C. to 285° C. within a period of about 2 to about 10 seconds, more preferably within a period of from about 2 to about 5 seconds, to induce melting. In such manner, generally from about 0.2 g to about 0.5 g of thermoplastic material can be melted and have its viscosity reduced to a level suitable for molding within about 4 seconds.

Thereafter, activation of the plunger assembly drive mechanism moves the plunger pin 134 toward the vibration element 130 forcing the molten thermoplastic material out of the melting chamber 146 and into the mold cavity 148 via runner 150. Generally, travel of the plunger pin toward the vibration element is controlled both in speed and distance to avoid the creation of excessive pressure and introduction of unwanted stress and strain into the molten material. In this regard, the terminal end of the plunger pin preferably approaches to no closer than 1.0 mm of the terminal end of the vibration element. Preferably, the end of the plunger pin approaches to within from about 2.0 mm to about 6.0 mm of the end of the vibration element. Further, movement of the plunger pin preferably imparts a force of no more than 12,000 N on the molten material to expel it from the melting chamber. Preferably, the plunger pin imparts a force of from about 2000 N to about 6000 N on the molten material.

The material is then cured in the mold cavity 148 to form a thin-walled, low birefringence, optical component. Preferably the optical component has a birefringence of less than about 30 nanometers retardation in refractive index. More preferably, the optical component is birefringence free. After curing, the mold blocks are separated and the resulting optical component is removed from the mold by appropriate means, such as ejection pins (not shown).

The method and apparatus of the invention are particularly well-suited for the molding of small optical components. In particular, optical components having a maximum external dimension (e.g., length or diameter) of less than about 35 mm, and a thickness of less than about 2.5 mm. More particularly, optical components having a maximum external dimension of from about 5.0 mm to about 10 mm, and a thickness of from about 0.025 mm to about 1.0 mm, more preferably having a thickness of from about 0.025 mm to about 0.30 mm. However, the invention is not limited to the fabrication of such small items and can be used advantageously in the formation of components of various sizes.

Although the invention has been described in reference to mold blocks 102 and 104 containing a single pair of mold inserts, it should be understood that they can include multiple pairs of mold inserts spaced around the melting chamber and connected thereto via separate runners. For example, four pairs of mold inserts may be spaced around the melting chamber (e.g., at the 12, 3, 6, and 9 o'clock positions with the melting chamber in the center) such that four optical components are formed by each molding cycle.

While the invention has been described and illustrated herein by references to various specific materials, procedures and examples, it is understood that the invention is not restricted to the particular combinations of material and procedures selected for that purpose. Numerous variations of such details can be implied as will be appreciated by those skilled in the art. It is intended that the specification and examples be considered as exemplary, only, with the true scope and spirit of the invention being indicated by the following claims.

What is claimed is:

1. An ultrasonic molding device for molding optical components, comprising:
a first mold block including a first mold insert having a first mold cavity defining portion, a horn chamber, and a first passageway formed along a mating surface of the first mold block between the horn chamber and the first mold cavity defining portion;
a second mold block including a second mold insert having a second mold cavity defining portion configured to operatively engage the first mold cavity defining portion, a plunger chamber configured to be axially aligned with the horn chamber, and a second passageway formed in a mating surface of the second mold block between the plunger chamber and the second mold cavity defining portion;
an ultrasonic assembly having a vibration element configured to be positioned in the horn chamber and switched between an inactive and active state, and
a plunger assembly comprising a plunger pin configured to reciprocate within the plunger chamber,
wherein the molding device is movable between an open and closed position, wherein in the closed position, the mating surface of the first mold block engages the mating surface of the second mold block such that the first mold cavity defining portion and the second mold cavity defining portion cooperatively form a mold cavity configured to form an optical component, the horn chamber and plunger chamber axially align to form a melting chamber, and the first passageway and the second passageway longitudinally align forming a runner configured to deliver molten thermoplastic material from the melting chamber to the mold cavity.

2. The ultrasonic molding device of claim 1, wherein the runner is formed orthogonal to the plunger chamber.

3. The ultrasonic molding device of claim 1, wherein the vibration element includes a sonotrode configured to be axially aligned with the horn chamber and moved between a first position and a second position to engage material provided in the melting chamber.

4. The ultrasonic molding device of claim 3, further including a material feed assembly configured to deliver thermoplastic material to the melting chamber.

5. The ultrasonic molding device of claim 1, wherein thermoplastic material is delivered to the melting chamber through an inlet formed in the horn chamber.

6. The ultrasonic molding device of claim 4, wherein the material feed assembly delivers thermoplastic material to an inlet formed in the horn chamber.

7. The ultrasonic molding device of claim 6, wherein movement of the sonotrode into the second position seals the inlet in the horn chamber.

8. The ultrasonic molding device of claim 1, wherein the plunger pin and the vibration element are axially aligned and move towards each other in opposing directions.

9. The ultrasonic molding device of claim 8, wherein the melting chamber is formed between a terminal end portion of the plunger pin and a terminal end portion of the vibration element.

10. The ultrasonic molding device of claim 9, wherein movement of the plunger pin toward the vibration element expels the molten thermoplastic material from the melting chamber through the runner to the mold cavity.

11. The ultrasonic molding device of claim 10, wherein the minimum distance between the terminal end portion of the vibration element and the terminal end portion of the plunger pin during expulsion of the molten thermoplastic material from the melting chamber is more than about 1.0 mm.

12. The ultrasonic molding device of claim 1, wherein the first mold cavity defining portion and the second mold cavity defining portion are configured to cooperatively form a thin-walled optical component having a thickness of from about 0.025 mm to 1.0 mm.

13. The ultrasonic molding device of claim 12, wherein the first mold cavity defining portion and second mold cavity defining portion are configured to cooperatively form a thin-walled optical component having a thickness in the range of from about 0.025 mm to about 0.30 mm.

14. The ultrasonic molding device of claim 1, wherein the first mold cavity defining portion has a concave mold surface configured to form an exterior portion of the optical component and the second mold cavity defining portion has a convex mold surface configured to form an interior portion of the optical component configured to engage a cornea of a user's eye.

15. The ultrasonic molding device of claim 11, wherein the terminal end of the plunger pin approaches to within about 2.0 mm to about 6.0 mm of the terminal end of the vibration element to expel molten thermoplastic material from the melting chamber.

16. The ultrasonic molding device of claim 1, wherein the force exerted on the molten thermoplastic material by the plunger pin is less than about 12,000 N.

17. The ultrasonic molding device of claim 16, wherein the force exerted on the molten thermoplastic material by the plunger pin is in the range of from about 2,000 N to about 6,000 N.

18. The ultrasonic molding device of claim 1, wherein the runner has a length of less than about 25 mm.

19. The ultrasonic molding device of claim 18, wherein the runner has a length in the range of from about 8 mm to about 20 mm.

20. The ultrasonic molding device of claim 1, wherein the runner has a cylindrical shape with a diameter in the range of from about 1 mm to about 5 mm.

21. The ultrasonic molding device of claim 1, wherein the runner has a ratio of cross-sectional area to length in the range of from about 0.2 to about 1.0.

22. A method of forming an optical component, comprising:
(a) providing a molding device comprising:
a first mold block including a first mold insert having a first mold cavity defining portion, a horn chamber configured to receive an ultrasonic assembly, and a first passageway formed along a mating surface of the first mold block,
a second mold block including a second mold insert having a second mold cavity defining portion, a plunger chamber configured to receive a plunger assembly, a second passageway formed along a mating surface of the second mold block configured to align with the first passageway,
an ultrasonic assembly including a vibration element, configured to move axially in the horn chamber, and
a plunger assembly including a plunger pin configured to move axially in the plunger chamber, and a material feeder capable of providing thermoplastic material to the horn chamber;
(b) placing the first mold block in engagement with the second mold block such that the first mold cavity defining portion and second mold cavity defining portion cooperatively form a mold cavity, the plunger chamber and horn chamber are aligned defining a melting chamber therein, and the first passageway and second passageway are aligned to form a runner between the mold cavity and the melting chamber;
(c) introducing solid thermoplastic material from the material feeder into the melting chamber;
(d) moving the vibration element into position in the horn chamber such that a terminal end portion of the vibration element is located adjacent to the thermoplastic material in the melting chamber;
(e) activating the ultrasonic assembly such that vibrational energy of a predetermined magnitude melts the thermoplastic material;
(f) moving the plunger pin in the plunger chamber towards the vibration element thereby expelling molten thermoplastic material through the runner into the mold cavity;
(g) curing the material in the mold cavity thereby forming an optical component; and
(h) demolding the optical component from the mold cavity.

23. The method of forming an optical component of claim 22, wherein the optical component has a thickness of less than about 2.5 mm.

24. The method of forming an optical component of claim 23, wherein the optical component has a thickness in the range of from about 0.025 mm to about 1.0 mm.

25. The method of forming an optical component of claim 22, wherein the runner has a length of less than about 25 mm.

26. The method of forming an optical component of 25, wherein the runner has a length in the range of from about 8 mm to about 20 mm.

27. The method of forming an optical component of claim 22, wherein the plunger pin exerts a maximum force of less than about 12,000 N on the thermoplastic material in the melting chamber.

28. The method of forming an optical component of claim 27, wherein the plunger pin exerts a force in the range of from about 2,000 N to about 6,000 N on the thermoplastic material in the melting chamber.

29. The method of forming an optical component of claim 22, wherein the runner has a ratio of cross-sectional area to length in the range of from about 0.2 to about 1.0.

30. The method of forming an optical component of claim 22, wherein the demolded optical component has a birefringence of less than about 30 nanometers of retardation in refractive index.

31. The method of forming an optical component of claim 30, wherein the demolded optical component has a birefringence of less than about 10 nanometers of retardation in refractive index.

32. The method of forming an optical component of claim 22, wherein the vibrational element generates power of a magnitude in the range of from about 1.0 kW to about 1.5 kW.

33. The method of forming an optical component of claim 22, wherein the residence time to melt the thermoplastic material in the melting chamber is less than about 10 seconds.

34. The method of forming an optical component of claim 22, wherein the cycle time from introduction of the thermoplastic material into the melting chamber to demolding of the formed optical component is less than about 90 seconds.

35. The method of claim 32, wherein the vibration induces a temperature of from about 200° C. to about 300° C. in the thermoplastic material.
